(19) United States
(12) Patent Application Publication
(10) Pub. No.: US 2026/0141351 A1
(43) Pub. Date: May 21, 2026

(54) METHOD AND SYSTEM FOR AI-DRIVEN PRIORITIZATION OF CLIENT MEETINGS AND PORTFOLIO REBALANCING FOR FINANCIAL ADVISORS

(71) Applicant: LTI Mindtree Ltd, Mumbai (IN)

(72) Inventor: Gunasiri Paththameistreege, South Plainfield, NJ (US)

(21) Appl. No.: 18/950,217

(22) Filed: Nov. 18, 2024

(51) Int. Cl. G06Q 10/1093; G06Q 30/0202; G06Q 40/06

(52) U.S. Cl. CPC G06Q 10/1093; G06Q 30/0202; G06Q 40/06

(57) ABSTRACT

The present disclosure provides a method and system leveraging AI/ML models for prioritizing client meetings and dynamically rebalancing portfolios for financial advisors. The system receives real-time market event data from multiple external sources, which is processed using AI/ML models and a RAG Architecture to assess impacts on financial sectors and client portfolios. Based on the analysis, the system generates a prioritized list of client meetings and pre-meeting materials that include actionable recommendations. These materials are displayed to the financial advisor via a user interface. The system further integrates with portfolio management systems to automate portfolio rebalancing based on the AI-generated recommendations and financial advisor input, ensuring alignment with client goals and market conditions.

### FIELD

Various embodiments of the present disclosure relate to an AI-driven method and system for assisting financial advisors. More particularly, the disclosure is directed toward using AI/ML models to prioritize client meetings and manage portfolios in real time, based on the analysis of multi-dimensional market event data and client-specific factors.

### BACKGROUND

Financial advisors face significant inefficiencies in meeting preparation, spending up to 70% of their time gathering market insights and internal data from disparate and unconnected systems. The goal is to deliver enhanced, data-driven recommendations to clients; however, this preparation consumes the majority of the advisor's time, leaving only 20% for engaging with clients such as High-Net-Worth Individuals (HNIs) or Ultra-High-Net-Worth Individuals (UHNIs). The absence of an integrated, real-time solution leads to a heavy overhead in synthesizing market data and client-specific information before each meeting.

This preparation process is further complicated by the lack of centralized data and unified messaging systems, causing critical information to be scattered across various sources and platforms. As data is frequently communicated through different channels, it becomes increasingly difficult to synthesize and analyze effectively. This fragmentation reduces the time available for personalized client interactions and strategic relationship-building, further limiting the advisor's ability to deliver timely and personalized financial advice.

This issue is global and complex, arising from multi-dimensional challenges that financial advisors face in their organizational ecosystems. These challenges include the dispersal of critical data across disparate systems, making integration and real-time access to information difficult. The absence of unified messaging and the lack of streamlined event management further complicate the preparation and execution of client meetings. Advisors require real-time data to make informed decisions, but this need is hindered by fragmented systems. Additionally, strict regulatory and compliance requirements demand meticulous record-keeping, adding a layer of complexity. Together, these factors create significant inefficiencies in client engagement and service delivery.

As a result, many clients feel that their financial advisors do not communicate frequently or promptly enough to meet their specific needs, which can lead to dissatisfaction and a breakdown in the client-advisor relationship.

The impact of market signals can vary widely across different portfolios, highlighting the need for personalized management of client demands. To address this, financial advisors require a ‘Single Pane of Glass’—a unified interface that consolidates internal and external data in real-time. Such a solution would provide a comprehensive and immediate view of relevant market and client information, enabling advisors to make faster and more informed decisions. By streamlining information access and minimizing the time spent on manual data gathering and analysis, this solution would significantly enhance the efficiency and effectiveness of client interactions.

### SUMMARY

A method and system for prioritizing client meetings for a financial advisor based on real-time analysis of market sentiments and events is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE FIGURES

FIG. 1 is a diagram that illustrates an exemplary environment 100 within which various embodiments of the present disclosure may function.

FIG. 2 is a diagram that illustrates a wealth advisory system 106 for prioritizing client meetings, in accordance with an embodiment of the disclosure.

FIG. 3 is a diagram that illustrates a flow chart 300 for a method for prioritizing client meetings, in accordance with an embodiment of the disclosure.

### DETAILED DESCRIPTION

Various embodiments of the present disclosure relate to a method and system for prioritizing client meetings for a financial advisor based on real-time analysis of market events. Data related to the market events is received from one or more external data sources by a server and is analyzed by an AI/ML model to determine the impact of the data related to the market events on one or more financial sectors and individual client portfolios. The server then generates a prioritized list of client meetings based on the determined impact of the data related to the market events. The server determines the prioritized list of client meetings by significance of the impact on the respective client portfolios. The server then automatically generates pre-meeting materials such as meeting notes, discussion items, and actionable recommendations for each prioritized client meeting based on the impact and historical client data. The prioritized list of client meetings along with the pre-meeting materials are displayed to the financial advisor via a user interface. The portfolios of the clients are rebalanced based on actionable recommendations and financial advisor's input, and the rebalancing is executed through integration with portfolio management systems.

The disclosed disclosure provides financial advisors with a unified, all-in-one solution for managing their operations. It delivers a 360° dashboard view by integrating data from various disparate systems, market signals, and sentiment analysis. Additionally, the disclosed disclosure offers proactive, intelligent insights into portfolio impacts, streamlines administrative tasks such as scheduling meetings, and tracks unified messaging and audit trails.

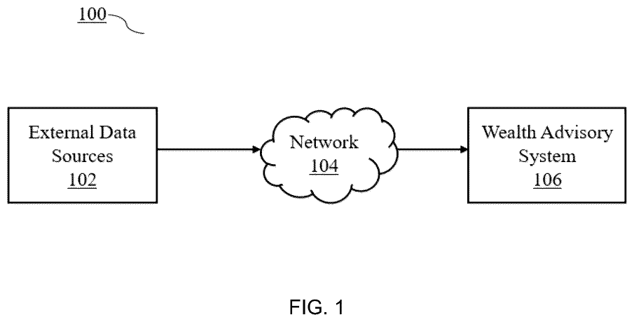

FIG. 1 is a diagram that illustrates an exemplary environment 100 within which various embodiments of the present disclosure may function. Referring to FIG. 1, the environment comprises external data sources 102, a network 104, and a wealth advisory system 106.

In one or more embodiments, the external data sources 102 can be a diverse array of sources where data related to market events is available. This may include aggregating information from various disparate systems, which may comprise market signal information systems, global financial events, financial news outlets, trading platforms, financial reports, economic indicators, brokerage platforms, stock exchanges, financial databases, financial advisory firms, credit rating agencies, bank policy changes, and economic reports. Market signal information systems may specifically include real-time trading data, price movements, while sentiment analysis involves evaluating public and investor sentiment (positive, negative, neutral) through social media, news articles, and other communication channels.

The network 104 includes communication networks operable to facilitate communication, either wirelessly or wired. Any of the communications networks may include, but are not limited to, any one of a combination of different types of suitable communications networks such as, for example, broadcasting networks, cable networks, public networks (for example, the Internet), private networks, wireless networks, cellular networks, or any other suitable private and/or public networks. Further, any of the communication networks may have any suitable communication range associated therewith and may include, for example, global networks (for example, the Internet), metropolitan area networks (MANs), wide area networks (WANs), local area networks (LANs), or personal area networks (PANs). In addition, any of the communications networks may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

The wealth advisory system 106 is a Generative Artificial Intelligence (GenAI) powered unique solution for financial advisors in the asset and wealth management. By utilizing the GenAI, the wealth advisory system 106 provides AI inferenced advisory recommendations and one-on-one real-time collaboration features to enable critical differentiators to both HNIs and institutes by providing hyper personalized user experience and advisory services.

In one or more embodiments, the wealth advisory system 106 that is AI powered, analyzes impact of market event data on one or more financial sectors and individual client portfolios and thereby generates a prioritized list of client meetings based on the significance of the impact on the portfolios. In addition to the prioritized client meetings, the wealth advisory system 106 that is AI powered also automatically generates pre-meeting materials to assist the financial advisor in each prioritized client meeting. The prioritized client meetings along with the pre-meeting materials are displayed via a user interface (UI), to the financial advisor to deliver a 360° dashboard view of intelligent insights into market impact analysis, portfolio analytics, client meeting priorities, meeting insights, and actionable recommendations, streamlined administrative tasks such as scheduling meetings.

In one or more embodiments, the pre-meeting materials facilitate the financial advisors to consume curated real-time market news for proactive notification and advise to clients, provide digital collaboration with external client and internal persona interaction, create relevant market research summary for client consumption, and audit trail. The displaying of the pre-meeting materials is to help the financial advisors to provide differentiated service offering to wealthy clients to cross sell, up-sell services with rebalancing option for client to retain and grow.

In an exemplary embodiment, the financial advisor can be at least one of an investment advisor, a wealth manager, a financial advisor, and a private banker. The financial advisor is a person or a company that provides advice to clients and potential buyers in a specific field. For example, a financial advisor provides advice to individuals and families on estate planning, financial planning, and retirement planning.

In various embodiments, the wealth advisory system 106 communicates with the external data sources 102 via the network 104. The various elements and modules of the wealth advisory system 106 communicates with the external data sources 102, either directly, or connect through an intermediate element, including via a cloud, internet, or intranet.

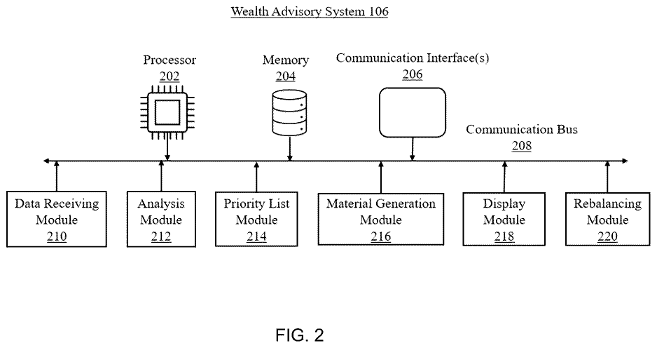

FIG. 2 is a diagram that illustrates the wealth advisory system 106 for prioritizing client meetings, in accordance with an embodiment of the disclosure. Referring to FIG. 2, the wealth advisory system 106 comprises a processor 202, a memory 204, one or more communication interface(s) 206, a communication bus 208, a data receiving module 210, an analysis module 212, a priority list module 214, a material generation module 216, a display module 218, and a rebalancing module 220.

The processor 202 may comprise suitable logic, interfaces, and/or code that may be configured to execute the instructions stored in the memory 204 to implement various functionalities of the wealth advisory system 106 in accordance with various aspects of the present disclosure. The processor 202 may be further configured to communicate with various modules of the wealth advisory system 106 via the communication bus 208.

The memory 204 may comprise suitable logic, and/or interfaces, that may be configured to store instructions (for example, computer-readable program code) that can implement various aspects of the present disclosure.

The communication interface(s) 206 may include one or more interfaces to enable the wealth advisory system 106 to access a computer network such as a Location Area Network (LAN), a Wide Area Network (WAN), a Personal Area Network (PAN), or the internet through a variety of wired and/or wireless connections, including cellular connections.

The communication bus 208 is configured to serve the wealth advisory system 106, facilitating seamless communication, integration, and coordination among its constituent components. Through its role as a centralized message broker, the communication bus 208 enables efficient data exchange, event-driven processing, and reliable communication, empowering c to orchestrate complex workflows and achieve outputs.

The data receiving module 210 may comprise suitable logic, interfaces, and/or code that may be configured to receive market event data from the external data sources 102. The external data sources 102 can be a diverse array of sources where data related to market events is available. The data related to the market events can be a real-time data or historical data which may include, but not limited to, market signal information systems, global financial events, financial news outlets, trading platforms, financial reports, economic indicators, brokerage platforms, stock exchanges, financial databases, financial advisory firms, credit rating agencies, bank data, and economic data. The real-time market event data can include information that is updated consistently or at frequent intervals to reflect current market conditions. The historical market event data can include past data that provides context and trends over time, useful for analysis and forecasting.

In various embodiments, the market signal information systems may specifically include real-time trading data, price movements, while sentiment analysis involves evaluating public and investor sentiment (positive, negative, neutral) through social media, news articles, and other communication channels.

The analysis module 212 may comprise suitable logic, interfaces, and/or code that may be configured to analyze and determine the impact of the market event data on one or more financial sectors and individual client portfolios.

In an exemplary embodiment, the analysis module 212 may assess the impact of new regulations or policy changes on different financial sectors. For instance, a tougher environmental regulation might affect the performance of industrial sectors, and the analysis module 212 can quantify these effects. In an instance, the analysis module 212 may consider broader economic trends such as inflation, interest rates, and economic growth, and analyzes their impact on various financial sectors.

In one or more embodiments, the analysis module 212 evaluates how market event data affects the valuation of assets with each individual client portfolio, which may include analyzing changes in stock prices, bond yields, and other financial instruments.

In one or more embodiments, the analysis module 212 leverages an artificial intelligence (AI)/machine learning (ML) model to analyze the market event data. The AI/ML model processes historical market event data in conjunction with real-time data to enhance accuracy in predicting the impact of current market events on financial sectors and client portfolios. In an instance, the AI/ML model may use one or more adaptive learning techniques to continuously improve its predictive capabilities based on new market event data that is ingested.

In one or more embodiments, the AI/ML model of the analysis module 212 leverages historical market event data to uncover patterns and trends that have historically influenced market dynamics. By analyzing past market behaviors, the AI/ML model can identify recurring patterns and anomalies.

In one or more embodiments, the AI/ML model processes the real-time market event data to ensure that the analysis reflects the most current market conditions, and dynamically adjust its predictions and impact assessments as new data emerges.

In one or more embodiments, the AI/ML model incorporates sentiment analysis of market news and social media content to determine an overall sentiment towards the financial sectors and one or more products relevant to the client portfolios. The overall sentiment data that is determined is used to weigh the impact of market events on financial sectors and the client portfolios.

By employing sentiment analysis, the AI/ML model analyzes the received market event data to assess positive, negative, and neutral sentiments. The AI/ML model may leverage natural language processing (NLP) techniques to understand the context and tone of the data related to the market events. The AI/ML model may aggregate the sentiment scores obtained from the market event data to determine the overall sentiment towards different financial sectors and one or more products relevant to the client portfolios. For instance, if a lot of positive news is coming out about renewable energy stocks, the sentiment towards that sector might be deemed bullish.

In one or more embodiments, the AI/ML model analyzes geographical impacts by evaluating how market events affect different regions and adjusts the impact assessment based on geographical relevance to the client portfolios. The geographical impact that is analyzed is evaluated by comparing it with geographic market trends and regional economic conditions.

In an exemplary embodiment, the AI/ML model collects data on financial markets from various regions, such as stock exchanges, commodity markets, and bond markets in different countries or states. It gathers economic indicators relevant to specific regions, such as GDP growth rates, unemployment rates, inflation, and consumer spending. The AI/ML model reviews news articles, economic reports, and industry analyses that provide insights into regional economic conditions and market developments.

In accordance with the exemplary embodiment, the AI/ML model performs sentiment analysis on a broader scale and assesses sentiment specifically within different regions, which may include regional news sentiment, local social media trends, and public sentiment related to local events. By evaluating regional economic conditions, the AI/ML model determines how broader economic factors are likely to influence market events and investment opportunities.

In one or more embodiments, the AI/ML model compares the geographical impact of market events with regional market trends and economic conditions. For instance, if a global trade agreement impacts multiple regions differently, the AI/ML model assesses how this agreement specifically affects the economic outlook and market performance in each relevant region. The impact on client portfolios is adjusted based on how geographically relevant the market events are to the portfolios. For example, if a client's portfolio has significant exposure to European markets, then changes in European economic conditions or market trends will be weighted more heavily in the impact assessment.

In one or more embodiments, the AI/ML model evaluates industry-specific impacts by analyzing how market events influence various industries relevant to the client's portfolio. The AI/ML model, upon evaluating, maps industry impacts individual financial instruments and sectors within the client portfolios to determine specific effects.

In an exemplary embodiment, the AI/ML model may collect and integrate data from various industries relevant to the client's portfolio, such as, for example, industry news, regulatory changes, and technological advancements. The AI/ML model identifies and tracks market events such as economic policy changes, geopolitical developments, technological innovations, and significant corporate actions that have implications for different industries.

In accordance with the exemplary embodiment, the AI/ML model assesses how specific market events influence various industries. The AI/ML model evaluates the sensitivity of each industry to market events. Some industries may be more volatile or reactive to certain events than others. For instance, technology stocks might be highly responsive to changes in interest rates due to their growth investment nature.

In accordance with the exemplary embodiment, the AI/ML model evaluates the sensitivity of each industry to market events. Some industries may be more volatile or reactive to certain events than others. For instance, technology stocks might be highly responsive to changes in interest rates due to their growth investment nature. The AI/ML model also looks at how industry-wide changes affect broader sectors within the portfolio. For example, if the healthcare sector is expected to benefit from new healthcare policies, the AI/ML model assesses how this might influence the performance of healthcare stocks and related financial instruments in the portfolio.

In one or more embodiments, the AI/ML model estimates the potential value changes in client portfolios based on industry impact analysis, calculating the specific risks associated with exposure to industries facing headwinds or growth opportunities.

In one or more embodiments, the AI/ML model integrates client-specific data including risk profiles, investment goals, and historical performance to customize the impact analysis for individual client portfolios.

In an exemplary embodiment, the AI/ML model incorporates each client's unique risk tolerance and investment preferences. For instance, a client with a high-risk tolerance might be more comfortable with volatile investments, whereas a client with a low-risk tolerance would prefer more stable and conservative assets. This risk profile helps the AI/ML model to determine how sensitive the client's portfolio should be to various market events and industry changes.

In an exemplary embodiment, the AI/ML model takes into account the investment goals of the client, such as retirement planning, wealth accumulation, or funding education. Each goal can influence the desired asset allocation and investment strategy. For example, a client saving for retirement might have different priorities and time horizons compared to someone investing for a short-term goal.

In an exemplary embodiment, the AI/ML model analyzes the past performance of the client's portfolio to understand how it has reacted to market events and industry changes previously. This historical data helps in identifying patterns and adjusting predictions based on past behavior. For instance, if a client's portfolio showed strong resilience during past market downturns, the AI/ML model might consider this in its impact analysis.

In one or more embodiments, by integrating these aspects, the AI/ML model derives a tailored impact analysis for individual client portfolios. The AI/ML model customizes predictions and risk assessments based on individual characteristics and needs of each client. This ensures that the analysis is relevant and actionable, considering not just general market trends but how they specifically relate to the client's financial situation and objectives.

In one or more embodiments, the AI/ML model utilizes predictive analytics to forecast future impacts of market events on financial sectors and the client portfolios based on current trends and historical data. The forecast enables generation of actionable insights and recommendations for financial advisors.

In accordance with the one or more embodiments, the AI/ML model uses predictive analytics techniques to project how upcoming market events such as economic shifts, geopolitical developments, or changes in fiscal policy could affect various financial sectors. For example, if the AI/ML model predicts a potential economic downturn, it will estimate how this might influence sectors like consumer discretionary or energy, which might be more sensitive to such changes.

In accordance with the one or more embodiments, the predictive analytics are grounded in a combination of current market trends and historical performance data. The AI/ML model examines how similar past events have affected the markets and applies these insights to current conditions. For instance, if previous instances of interest rate hikes led to declines in technology stocks, the AI/ML model might forecast a similar trend in the future if rates are expected to rise again.

In one or more embodiments, based on these forecasts, the AI/ML model generates actionable insights tailored to the needs of financial advisors. These insights might include recommendations for adjusting portfolio allocations, identifying potential investment opportunities, or mitigating risks. For example, if the AI/ML model predicts that a particular sector is likely to perform well due to favorable market conditions, it might suggest increasing exposure to that sector.

In one or more embodiments, the AI/ML model employs clustering techniques to group similar market events and their effects on financial sectors, facilitating pattern recognition and trend analysis that influence the impact on the clients' portfolios.

In an exemplary embodiment, the clustering techniques group similar data points together based on certain features or characteristics. In the context of market events, clustering involves grouping events that share common attributes or patterns such as, for instance, a TICKER symbol or an industry segment. The AI/ML model uses clustering to categorize various market events into distinct groups. These groups are formed based on historical data and observed effects on financial sectors. For example, events that historically lead to increased volatility in technology stocks might be clustered together, while those causing shifts in commodity prices might form a different cluster.

In one or more embodiments, by grouping similar market events, the AI/ML model can identify patterns and recurring themes. Recognizing these patterns helps in understanding how specific types of events generally influence financial sectors. For example, if a cluster of events tends to lead to a downturn in the financial sector, this pattern can be used to anticipate similar impacts in future scenarios.

Clustering also facilitates trend analysis by showing how grouped events affect financial sectors over time. This analysis can reveal long-term trends and seasonal effects, such as how certain economic cycles impact different sectors. For instance, if a cluster of events related to monetary policy typically affects consumer discretionary stocks in a particular way, this trend can be anticipated and monitored.

The insights gained from clustering and trend analysis are then applied to understand how similar future events might impact client portfolios. By recognizing patterns and trends, the AI/ML model can forecast potential effects on different sectors within a client's portfolio. For example, if the model identifies a cluster of events that historically leads to higher returns in healthcare stocks, it might suggest adjusting the portfolio to capitalize on this trend.

The priority list module 214 may comprise suitable logic, interfaces, and/or code configured to generate a prioritized list of client meetings based on the results of the analysis performed by the analysis module 212. The priority list module 214 determines the order of client meetings based on the significance of the impact as assessed by the analysis module 212, ensuring that clients with the most critical needs are addressed first.

In one or more embodiments, the priority list module 214 receives the results of the impact analysis performed by the analysis module 212, which assesses market events, industry changes, or other relevant factors. Based on these results, the priority list module 214 determines the order of client meetings, prioritizing those clients whose financial situations are most affected by the assessed impacts.

Based on the analysis results provided by the analysis module 212, the priority list module 214 generates a prioritized list of client meetings. The module ranks clients in order of priority by considering the significance of the impact on their portfolios as determined by the analysis module 212.

In one or more embodiments, the priority list module 214 organizes client meetings based on the evaluation of each impact provided by the analysis module 212. The priority list is generated by assessing the severity of the impact on client portfolios and scheduling meetings accordingly.

In an exemplary embodiment, the priority list module 214 uses the analysis results provided by the analysis module 212, which identifies the immediate financial implications of market events on client portfolios. Clients facing significant financial impacts are prioritized for earlier meetings.

In one or more embodiments, the priority list module 214 assigns priority scores to each client based on the significance of the impact as determined by the analysis module 212. These scores are then used to rank clients and generate a prioritized list of meetings.

In one or more embodiments, the priority list module 214 uses the analysis module 212's assessment of the significance of the impact, which is based on deviations from expected portfolio performance. The priority list module 214 uses this information to organize client meetings.

In one or more embodiments, the priority list module 214 relies on the analysis module 212 to calculate the degree of deviation between actual and expected portfolio performance. Based on this analysis, the priority list module 214 ranks clients for meeting scheduling.

In one or more embodiments, the priority list module 214 uses the sector-specific and asset-level analysis provided by the analysis module 212 to determine how market events impact different parts of the portfolio. This information helps the priority list module 214 schedule meetings based on the severity of these impacts.

In an exemplary embodiment, the priority list module 214 receives the immediate financial implications of market events on client portfolios from the analysis module 212. These short-term effects, such as temporary losses, reduced returns, or increased volatility, are quantified by the analysis module 212 using volatility analysis and performance deviation metrics. Based on this analysis, the priority list module 214 organizes clients according to the urgency of addressing these issues, enabling financial advisors to make timely adjustments to minimize losses.

In addition to short-term impacts, the priority list module 214 receives the results of long-term consequence evaluations from the analysis module 212. The analysis module applies trend analysis algorithms and growth forecasting models to assess how ongoing market events might influence future performance, growth potential, or the achievement of long-term financial objectives. Based on these insights, the priority list module 214 prioritizes client meetings, enabling financial advisors to plan for strategic adjustments that align with each client's long-term goals.

In one or more embodiments, the priority list module 214 integrates short-term and long-term effects, as provided by the analysis module 212, to create a comprehensive view of the impact's significance. The analysis module 212 applies multi-horizon impact analysis, evaluating how immediate market volatility interacts with long-term growth potential. For example, a market event that causes short-term volatility but presents long-term growth opportunities may be prioritized differently from an event causing sustained losses. By combining short-term urgency with long-term ramifications, the priority list module 214 optimally prioritizes client meetings. Clients facing immediate risks are scheduled for urgent consultations, while those with long-term strategic concerns may be scheduled for more in-depth, strategic discussions.

Based on the significance determined from deviations and financial implications provided by the analysis module 212, the priority list module 214 integrates the prioritized list with a client calendar system using automated scheduling algorithms. The priority list module 214 automatically schedules client meetings, prioritizing those with the most critical issues, such as large deviations from expected performance or significant financial impacts. By leveraging real-time calendar integration, financial advisors can ensure that meetings are aligned with both the urgency of portfolio adjustments and the advisor's availability.

The material generation module 216 may comprise suitable logic, interfaces, and/or code that may be configured to automatically generate pre-meeting materials, including meeting notes, discussion items, and actionable recommendations. The module integrates with the AI/ML impact assessment system, which processes both real-time market event data and historical client data using deep learning models such as recurrent neural networks (RNNs) to analyze portfolio trends. Additionally, the module uses predictive analytics to forecast the potential impact of market events on the client's portfolio, ensuring that all generated materials are contextually relevant and tailored to each client's needs.

In one or more embodiments, the generation of pre-meeting materials involves summarizing key points from the AI-driven impact analysis of market events on the client's portfolio. The material generation module 216 module leverages natural language generation (NLG) techniques to automatically generate textual summaries, ensuring that the FA is prepared for the meeting. The wealth advisory system 106 identifies key discussion topics using topic modeling algorithms such as Latent Dirichlet Allocation (LDA) to highlight relevant market trends, RAG (Retrieval augmented Generation) Architecture with LLM to get prompted query responses with model finetuning get relevant response to a given FA query, portfolio performance metrics, and investment opportunities. Furthermore, the wealth advisory system 106 formulates customized investment strategies by applying multi-factor optimization algorithms that account for the impact of market events and client-specific factors, such as risk tolerance and investment goals.

The material generation module 216 generates pre-meeting notes by utilizing text summarization algorithms based on transformer models such as BERT or GPT to provide concise yet comprehensive recaps of recent market developments, previous meeting outcomes, and any outstanding issues. The material generation module 216 uses contextual analysis, incorporating AI-powered insights derived from the latest impact analysis and client-specific factors to identify key discussion items. By leveraging these insights, the wealth advisory system 106 ensures that relevant topics are highlighted, facilitating a more productive and focused discussion. Additionally, the material generation module 216 generates actionable recommendations using machine learning models that predict the optimal actions based on historical data and real-time impact assessments.

In one or more embodiments, the material generation module 216 distills key points from the AI/ML-driven impact analysis of market events on the client's portfolio. The present disclosure uses explainable AI (XAI) techniques to generate clear and concise explanations of how recent market developments affect the portfolio, providing transparency into the decision-making process. The material generation module 216 also identifies critical topics using sentiment analysis and risk assessment algorithms, ensuring that the FA is alerted to recent market trends, potential risks, and investment opportunities. These topics are highlighted dynamically based on real-time market data and client-specific portfolio performance metrics.

Based on the impact of market events and the specific needs of the client's portfolio, the material generation module 216 uses multi-objective optimization algorithms to formulate customized investment strategies and portfolio adjustments. The wealth advisory system 106 factors in the client's financial goals, risk tolerance, and historical portfolio performance, dynamically adjusting recommendations using real-time data inputs. The AI-driven strategy formulation process ensures that the recommendations are tailored to the client's unique financial profile and market exposure, optimizing portfolio performance under varying economic conditions.

By generating detailed and relevant pre-meeting materials, the material generation module 216 uses AI-driven insights to help FAs better prepare for client interactions. This preparation process involves generating a comprehensive overview of the client's current portfolio status using portfolio performance analytics, assessing the impact of recent market events through real-time data processing, and proposing strategic adjustments derived from machine learning models.

Consider an exemplary embodiment where a significant market event has negatively impacted a client's tech investments. The material generation module 216 automatically generates a meeting agenda using AI-powered impact analysis. This agenda includes a real-time summary of the event's effects on the portfolio, generated using predictive analytics models. The material generation module 216 identifies discussion items, such as potential portfolio adjustments or alternative investments, by applying optimization algorithms that simulate potential outcomes based on different scenarios. Specific recommendations for mitigating the negative impact are generated using machine learning techniques that factor in historical data and real-time market conditions, providing a complete package of tailored meeting notes, discussion items, and recommendations for the FA.

In one or more embodiments, the material generation module 216 customizes the pre-meeting materials based on at least one of a client's individual risk profile, financial goals, and historical portfolio performance; and real-time impact assessments. Further, the material generation module 216 customizes the pre-meeting materials including meeting notes, discussion items, and actionable recommendations based on client's individual risk profile, financial goals, historical portfolio performance; and real-time impact assessments are recorded in a client relationship management (CRM) system.

The display module 218 may comprise suitable logic, interfaces, and/or code that may be configured to display, via the user interface, the prioritized list of client meetings, along with the pre-meeting materials to the financial advisor.

In some non-limiting embodiments, the display module 218 is also configured to allow the financial advisor to manually adjust the prioritization based on one or more factors.

The wealth advisory system 106 may comprise a collaboration module, which is configured to offer a multi-modal communication interface facilitating seamless interaction between the FA and a client. The collaboration module supports various communication channels, including but not limited to text, voice, and video, through the use of APIs that integrate with third-party communication services. Real-time engagement is enabled during scheduled or impromptu meetings through an event-driven architecture that processes incoming data streams with minimal latency. The collaboration module further integrates Generative AI capabilities using transformer-based language models (e.g., GPT) to dynamically generate responses and suggestions in real-time based on conversation context, enhancing the quality of the interaction.

The Generative AI functionality within the collaboration module leverages advanced natural language processing (NLP) techniques to dynamically assist the FA during client interactions. The AI/ML model is based on a transformer architecture, such as BERT or GPT, which has been fine-tuned with financial data and client interaction transcripts. This model is trained to analyze the conversation flow, client queries, and financial data in real-time. By using contextual embeddings, the AI/ML model understands the semantic meaning behind client inquiries and generates contextually relevant responses. The model also integrates with a knowledge base of financial data, allowing it to access up-to-date market conditions, client portfolio information, and historical trends, ensuring that the FA receives accurate, real-time suggestions without manual data retrieval.

The collaboration module may generate real-time insights, recommendations, or clarifications based on data inputs such as the client's portfolio, current market conditions, and specific financial goals. This is achieved through the integration of predictive analytics models that process financial data streams using recurrent neural networks (RNNs) or long short-term memory (LSTM) networks, which are specifically designed to analyze time-series financial data. Additionally, the NLP model can cross-reference client-specific goals with real-time market conditions using named entity recognition (NER) to extract relevant financial instruments and market events. This enables the wealth advisory system 106 to provide highly personalized recommendations and clarify complex financial scenarios during client meetings. The predictive and NLP models ensure that financial advisors receive actionable insights that are contextually accurate, thereby improving the quality and efficiency of client discussions.

This multi-modal communication interface, combined with advanced AI support, ensures that the FA can provide immediate, data-backed responses, streamlining client interactions and enhancing the overall decision-making process.

The rebalancing module 220 may comprise suitable logic, interfaces, and/or code that may be configured to perform automated portfolio rebalancing based on actionable recommendations generated by an AI/ML model and input provided by the financial advisor. The rebalancing module 220 is designed to optimize the portfolio's asset allocation in accordance with the client's risk profile, financial goals, and market conditions. By processing these factors, the rebalancing module 220 ensures that the client's portfolio is aligned with both long-term objectives and short-term market fluctuations.

The AI/ML model in the rebalancing module 220 leverages historical data and real-time market information to dynamically generate rebalancing recommendations. The AI/ML model uses clustering techniques to group portfolios with similar asset compositions, analyzing patterns such as portfolio volatility, sector performance, and correlation among assets. Based on these patterns, the AI/ML model identifies optimal rebalancing strategies to minimize risk and maximize potential returns. Additionally, the AI/ML model continually updates its learning process by incorporating the outcomes of previous rebalancing decisions into future recommendations.

In one or more embodiments, the rebalancing module 220 is integrated with one or more portfolio management systems, allowing it to directly execute portfolio adjustments without requiring manual intervention. This integration facilitates seamless rebalancing operations, enabling faster and more efficient implementation of strategy changes across multiple client portfolios.

Furthermore, in one or more embodiments, the rebalancing module 220 allows the financial advisor to interact with the system, providing input to refine or override automated rebalancing recommendations. This may include adjusting rebalancing strategies based on their professional expertise, accommodating specific client preferences, or tailoring strategies to meet unique investment goals. The ability to customize rebalancing decisions ensures that the financial advisor maintains full control over the portfolio management process, while leveraging the system's automated capabilities to enhance efficiency and accuracy.

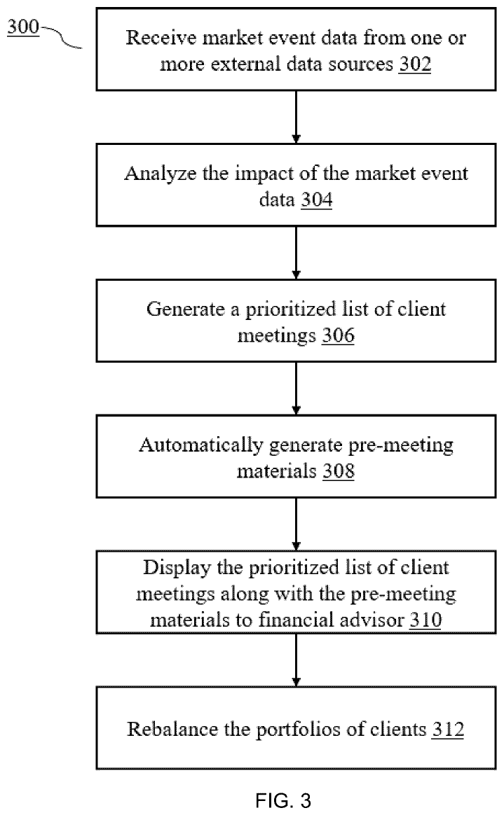

FIG. 3 is a diagram that illustrates a flow chart 300 for a method for prioritizing client meetings, in accordance with an embodiment of the disclosure.

At 302, the data receiving module 210 receives market event data from the external data sources 102. The external data sources 102 can be a diverse array of sources where data related to market events is available. The data related to the market events can be a real-time data or historical data which may include, but not limited to, market signal information systems, global financial events, financial news outlets, trading platforms, financial reports, economic indicators, brokerage platforms, stock exchanges, financial databases, financial advisory firms, credit rating agencies, bank data, and economic data. The real-time market event data can include information that is updated consistently or at frequent intervals to reflect current market conditions. The historical market event data can include past data that provides context and trends over time, useful for analysis and forecasting.

In various embodiments, the market signal information systems may specifically include real-time trading data, price movements, while sentiment analysis involves evaluating public and investor sentiment (positive, negative, neutral) through social media, news articles, and other communication channels.

At 304, the analysis module 212 analyzes and determine the impact of the market event data on one or more financial sectors and individual client portfolios.

In one or more embodiments, the analysis module 212 evaluates how market event data affects the valuation of assets with each individual client portfolio, which may include analyzing changes in stock prices, bond yields, and other financial instruments.

In one or more embodiments, the analysis module 212 leverages an artificial intelligence (AI)/Machine Learning (ML) model and a RAG architecture to analyze the market event data based on contextual search. The AI/ML model processes historical market event data in conjunction with real-time data to enhance accuracy in predicting the impact of current market events on financial sectors and client portfolios. In an instance, the AI/ML model may use one or more adaptive learning techniques to continuously improve its predictive capabilities based on new market event data that is ingested.

In one or more embodiments, the AI/ML model of the analysis module 212 leverages historical market event data to uncover patterns and trends that have historically influenced market dynamics. By analyzing past market behaviors, the AI/ML model can identify recurring patterns and anomalies.

In one or more embodiments, the AI/ML model processes the real-time market event data to ensure that the analysis reflects the most current market conditions, and dynamically adjust its predictions and impact assessments as new data emerges.

In one or more embodiments, the AI/ML model incorporates sentiment analysis of market news and social media content to determine an overall sentiment towards the financial sectors and one or more products relevant to the client portfolios. The overall sentiment data that is determined is used to weigh the impact of market events on financial sectors and the client portfolios.

By employing sentiment analysis, the AI/ML model analyzes the received market event data to assess positive, negative, and neutral sentiments. The AI/ML model may leverage natural language processing (NLP) techniques to understand the context and tone of the data related to the market events. The AI/ML model may aggregate the sentiment scores obtained from the market event data to determine the overall sentiment towards different financial sectors and one or more products relevant to the client portfolios. For instance, if a lot of positive news is coming out about renewable energy stocks, the sentiment towards that sector might be deemed bullish.

In one or more embodiments, the AI/ML model analyzes geographical impacts by evaluating how market events affect different regions and adjusts the impact assessment based on geographical relevance to the client portfolios. The geographical impact that is analyzed is evaluated by comparing it with geographic market trends and regional economic conditions.

In one or more embodiments, the AI/ML model compares the geographical impact of market events with regional market trends and economic conditions. For instance, if a global trade agreement impacts multiple regions differently, the AI/ML model assesses how this agreement specifically affects the economic outlook and market performance in each relevant region. The impact on client portfolios is adjusted based on how geographically relevant the market events are to the portfolios. For example, if a client's portfolio has significant exposure to European markets, then changes in European economic conditions or market trends will be weighted more heavily in the impact assessment.

In one or more embodiments, the AI/ML model evaluates industry-specific impacts by analyzing how market events influence various industries relevant to the client's portfolio. The AI/ML model, upon evaluating, maps industry impacts individual financial instruments and sectors within the client portfolios to determine specific effects.

In one or more embodiments, the AI/ML model estimates the specific effect of industry impacts on the client's portfolio, which may involve calculating potential changes in the value of the portfolio holdings based on the industry impact analysis. The AI/ML model assesses the risks associated with the identified impacts. For example, if an industry is expected to face significant headwinds, the model evaluates the risk of portfolio exposure to that industry.

In one or more embodiments, the AI/ML model integrates client-specific data including risk profiles, investment goals, and historical performance to customize the impact analysis for individual client portfolios.

In one or more embodiments, the AI/ML model utilizes predictive analytics to forecast future impacts of market events on financial sectors and the client portfolios based on current trends and historical data. The forecast enables generation of actionable insights and recommendations for financial advisors.

In accordance with the one or more embodiments, the AI/ML model uses predictive analytics techniques to project how upcoming market events such as economic shifts, geopolitical developments, or changes in fiscal policy could affect various financial sectors. For example, if the AI/ML model predicts a potential economic downturn, it will estimate how this might influence sectors like consumer discretionary or energy, which might be more sensitive to such changes.

In accordance with the one or more embodiments, the predictive analytics are grounded in a combination of current market trends and historical performance data. The AI/ML model examines how similar past events have affected the markets and applies these insights to current conditions. For instance, if previous instances of interest rate hikes led to declines in technology stocks, the AI/ML model might forecast a similar trend in the future if rates are expected to rise again.

In one or more embodiments, based on these forecasts, the AI/ML model generates actionable insights tailored to the needs of financial advisors. These insights might include recommendations for adjusting portfolio allocations, identifying potential investment opportunities, or mitigating risks. For example, if the AI/ML model predicts that a particular sector is likely to perform well due to favorable market conditions, it might suggest increasing exposure to that sector.

In one or more embodiments, the AI/ML model employs clustering techniques to group similar market events and their effects on financial sectors, facilitating pattern recognition and trend analysis that influence the impact on the clients' portfolios.

In an exemplary embodiment, the clustering techniques group similar data points together based on certain features or characteristics. In the context of market events, clustering involves grouping events that share common attributes or patterns. The AI/ML model uses clustering to categorize various market events into distinct groups. These groups are formed based on historical data and observed effects on financial sectors. For example, events that historically lead to increased volatility in technology stocks might be clustered together, while those causing shifts in commodity prices might form a different cluster.

In one or more embodiments, by grouping similar market events, the AI/ML model can identify patterns and recurring themes. Recognizing these patterns helps in understanding how specific types of events generally influence financial sectors. For example, if a cluster of events tends to lead to a downturn in the financial sector, this pattern can be used to anticipate similar impacts in future scenarios.

At 306, the priority list module 214 generates a prioritized list of client meetings based on the analysis of the impact. The priority list module 214 determines the prioritization based on significance of the impact on the respective client portfolios.

In one or more embodiments, the priority list module 214 analyzes the impact of market events, industry changes, or other relevant factors on client portfolios. This analysis helps determine the significance of these impacts on each client's financial situation. For example, if a market downturn is expected to significantly affect a client's portfolio, the module will assess the severity and potential consequences of this impact.

Based on the analysis, the priority list module 214 generates a prioritized list of client meetings. This list ranks clients in order of priority, considering how significantly the impact affects their portfolios. The prioritization could be influenced by several factors, such as the magnitude of the potential impact, the urgency of required actions, or the client's overall risk exposure.

In one or more embodiments, the priority list module 214 evaluates how each identified impact affects client portfolios. For instance, if one client is facing a major risk due to significant market volatility, their meeting might be given higher priority than a client experiencing a minor adjustment. The prioritization process considers the degree of change required in the portfolio, the potential financial implications, and the urgency of addressing these issues. Clients with portfolios that need immediate adjustments due to high-impact events will be prioritized over others.

In one or more embodiments, the priority list module 214 determines the significance of the impact based on one or more of a degree of deviation from expected portfolio performance as influenced by the market events and potential financial implications for the client, considering both short-term and long-term effects on their investments. Each client's portfolio is typically benchmarked against expected performance metrics, which are based on predefined goals, historical data, and market conditions. These benchmarks represent what the portfolio was anticipated to achieve under normal circumstances.

In one or more embodiments, the priority list module 214 calculates the degree to which actual portfolio performance deviates from these expectations due to market events. For example, if a market downturn causes a portfolio to underperform significantly compared to its expected return, this deviation is quantified and assessed. Deviations are often measured in terms of percentage changes, value shifts, or relative performance against benchmarks. Significant deviations indicate a higher priority for review and intervention.

In one or more embodiments, the priority list module 214 determines the extent of the impact of these events on different sectors and individual assets within the portfolio. This assessment helps in understanding the severity of the changes and their relevance to each client.

At step 308, the material generation module 216 automatically generates pre-meeting materials such as meeting notes, discussion items, and actionable recommendations for each prioritized client meeting based on the impact and historical client data.

In one or more embodiments, the pre-meeting materials comprise summarizing key points from the impact analysis of market events on the client's portfolio to prepare the FA for the meeting; identifying key topics relevant to the client's portfolio performance, market trends, and investment opportunities based on the impact analysis; and formulating customized investment strategies and portfolio adjustments based on the impact of market events and the client's portfolio need.

The material generation module 216 generates pre-meeting notes that summarize key information needed for the meeting. This includes a recap of recent developments, previous meeting outcomes, and any outstanding issues that need to be addressed. It identifies and outlines key discussion items based on the latest impact analysis and client-specific factors. This ensures that all relevant topics are covered during the meeting, facilitating a productive and focused discussion. The material generation module 216 provides actionable recommendations tailored to each client's situation. These recommendations are derived from the impact analysis of market events and historical client data, helping FAs to make informed decisions and propose relevant actions during the meeting.

In one or more embodiments, the material generation module 216 distills key points from the impact analysis of market events on the client's portfolio. This summary includes a clear explanation of how recent market developments affect the portfolio, enabling the FA to quickly understand the context and prepare for the meeting. It identifies critical topics relevant to the client's portfolio performance, such as recent market trends, potential risks, and investment opportunities. These topics are highlighted to ensure that the meeting addresses all pertinent issues and leverages current market insights.

At 310, the display module 218 displays, via the user interface, the prioritized list of client meetings, along with the pre-meeting materials to the financial advisor. In some non-limiting embodiments, the display module 218 is also configured to allow the financial advisor to manually adjust the prioritization based on one or more factors.

The wealth advisory system 106 may comprise a collaboration module, which is configured to offer a multi-modal communication interface facilitating seamless interaction between the FA and a client. This module supports various communication channels, including but not limited to text, voice, and video, enabling real-time engagement during scheduled or impromptu meetings. The collaboration module further enhances the interaction by integrating Generative AI capabilities.

The Generative AI functionality within the collaboration module may be configured to dynamically assist the FA during client interactions by generating contextually relevant answers to questions posed by the client. The Generative AI is trained to analyze the discussion flow, client queries, and available financial data, and may provide suggestions or automated responses based on the context. This capability enables the FA to address client concerns more efficiently and accurately, without the need to manually search through extensive data during the meeting.

Moreover, the collaboration module may generate insights, recommendations, or clarifications in real-time, based on the client's portfolio, market conditions, and specific financial goals. By leveraging AI-driven natural language processing and predictive analytics, the wealth advisory system 106 can help FAs engage in more informed discussions, thereby improving the quality and efficiency of client meetings.

This multi-modal communication interface, combined with advanced AI support, ensures that the FA can provide immediate, data-backed responses, streamlining client interactions and enhancing the overall decision-making process.

At 312, the method performs automated portfolio rebalancing, using the rebalancing module 220, based on actionable recommendations generated by the wealth advisory system 106 and input provided by the financial advisor. The rebalancing module 220 is designed to optimize the portfolio's asset allocation in accordance with the client's risk profile, financial goals, and market conditions. By processing these factors, the rebalancing module 220 ensures that the client's portfolio is aligned with both long-term objectives and short-term market fluctuations.

In one or more embodiments, the rebalancing module 220 is integrated with one or more portfolio management systems, allowing it to directly execute portfolio adjustments without requiring manual intervention. This integration facilitates seamless rebalancing operations, enabling faster and more efficient implementation of strategy changes across multiple client portfolios.

Furthermore, in one or more embodiments, the rebalancing module 220 allows the financial advisor to interact with the wealth advisory system 106, providing input to refine or override automated rebalancing recommendations. This may include adjusting rebalancing strategies based on their professional expertise, accommodating specific client preferences, or tailoring strategies to meet unique investment goals. The ability to customize rebalancing decisions ensures that the financial advisor maintains full control over the portfolio management process, while leveraging the system's automated capabilities to enhance efficiency and accuracy.

The present disclosure is advantageous in a manner that it offers a significant technical advancement by leveraging AI/ML algorithms to analyze real-time events and developments, which assess their impact on financial sectors and client portfolios. This enables Financial Advisors (FAs) to prioritize client engagements and tailor recommendations efficiently. Unlike conventional systems that provide generic market insights, the disclosed system dynamically evaluates global events, market sentiment, and geographical data to generate highly personalized insights for each client's portfolio, leading to more informed and timely decision-making.

Furthermore, the system efficiently generates and updates client risk profiles by analyzing entitlements, investments, and transactions in real-time, thus providing FAs with a comprehensive understanding of the client's financial standing. This technical solution reduces manual analysis efforts and enhances accuracy, making the financial advisory process faster and more effective.

The method and system also optimizes the scheduling of meetings based on the predicted future impact on portfolios, further enhancing the efficiency of client interaction. The ability to evaluate and incorporate performance analytics, asset master data, and event-driven market predictions into the advisory process demonstrates the technical superiority of the system over traditional approaches, which rely heavily on static data and historical trends.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of ordinary skills in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A computer-implemented method for prioritizing client meetings for a financial advisor based on real-time analysis of market events, the method comprising:
receiving, by a server, market event data from one or more external data sources;
analyzing, by an AI/ML model and a RAG Architecture executed on the server, an impact of the market event data on one or more financial sectors and individual client portfolios;
generating, by the server, a prioritized list of client meetings, based on the analyzing of the impact, wherein the prioritization is determined by significance of the impact of the market event data on the respective client portfolios;
automatically generating, by the server, pre-meeting materials comprising meeting notes, discussion items, and actionable recommendations for each prioritized client meeting, wherein the pre-meeting materials are based on the impact of the market event data and historical client data;
displaying, via a user interface, the prioritized list of client meetings along with the pre-meeting materials to the financial advisor; and
rebalancing, by the server, the portfolios of clients based on the actionable recommendations generated by the AI/ML model and an input from the financial advisor, wherein the rebalancing is executed through integration with one or more portfolio management systems.

2. The method of claim 1, wherein, the AI/ML model processes historical market event data in conjunction with real-time data to enhance accuracy in predicting the impact of current market events on financial sectors and client portfolios, wherein the AI/ML model dynamically adjusts the analysis based on historical performance trends of the financial sectors and individual client portfolios.

3. The method of claim 1, wherein the AI/ML model incorporates sentiment analysis of market news and social media content to determine an overall sentiment data towards financial sectors and one or more products relevant to the client portfolios, wherein the overall sentiment data is used to adjust the impact of the market events on the financial sectors and the client portfolios.

4. The method of claim 1, wherein the AI/ML model analyzes geographical impacts by evaluating how the market events affect different regions and adjusts impact assessment based on geographical relevance to the client portfolios, wherein the impact is evaluated by comparing regional market trends and economic conditions.

5. The method of claim 1, wherein the AI/ML model evaluates industry-specific impacts by analyzing how the market events influence industries relevant to the client portfolios, wherein the AI/ML model maps industry impacts to individual financial instruments and sectors within the client portfolios to determine specific effects.

6. The method of claim 1, wherein the AI/ML model integrates client-specific data including risk profiles, investment goals, and historical performance to customize the impact analysis for individual client portfolios.

7. The method of claim 1, wherein the AI/ML model utilizes predictive analytics to forecast future impacts of the market events on financial sectors and the client portfolios based on current trends and historical data, wherein the forecast generates actionable insights and recommendations for the financial advisor.

8. The method of claim 1, wherein the AI/ML model employs clustering techniques to group similar market events of the market events and their effects on financial sectors, facilitating pattern recognition and trend analysis that influence impact assessment on the client portfolios.

9. The method of claim 1, wherein generating the prioritized list of client meetings comprises:
assigning priority scores to each client based on the significance of the impact of the analyzed market events on their respective portfolios; and
ranking clients by their priority scores to create a list of meetings, ordered according to urgency and importance of addressing each client's portfolio needs.

10. The method of claim 9, wherein the significance of the impact is determined based on one or more of a degree of deviation from expected portfolio performance as influenced by the market events and potential financial implications for the client, considering both short-term and long-term effects on their investments.

11. The method of claim 1, wherein, the automatically generating pre-meeting materials comprising:
summarizing key points from the impact analysis of the market events on the client's portfolio to prepare the financial advisor for the meeting;
identifying key topics relevant to a client's portfolio performance, market trends, and investment opportunities based on the impact analysis; and
formulating customized investment strategies and portfolio adjustments based on the impact of the market events and specific needs of the client's portfolio.

12. The method of claim 1, wherein, the pre-meeting materials are customized based on at least one of a client's individual risk profile, financial goals, and historical portfolio performance; and real-time impact assessments.

13. The method of claim 1, wherein the pre-meeting materials including meeting notes, discussion items, and actionable recommendations are customized based on client's individual risk profile, financial goals, historical portfolio performance; and real-time impact assessments are recorded in a client relationship management (CRM) system.

14. The method of claim 1, further comprising integrating the prioritized list with a calendar system to automatically schedule the prioritized client meetings.

15. The method of claim 1, wherein the user interface allows the financial advisor to manually adjust the prioritization of client meetings based on one or more factors.

16. The method of claim 1, further comprising:
providing a detailed impact report that includes analysis of market news, geographical impact, sentiment determination, and industry impact; and
delivering actionable insights and predictive recommendations to the financial advisor to enhance client interactions and portfolio management.

17. A system for prioritizing client meetings for a financial advisor based on real-time analysis of market events, the system comprising:
a memory; and
a processor communicatively coupled with the memory, wherein the processor is configured to:
receive market event data from one or more external data sources;
analyze, using an AI/ML model, an impact of the market event data on one or more financial sectors and individual client portfolios;
generate a prioritized list of client meetings based on the analysis of the impact, wherein the prioritization is determined by significance of the impact on the respective client portfolios;
automatically generate pre-meeting materials including meeting notes, discussion items, and actionable recommendations for each prioritized client meeting based on the impact and historical client data;
display the prioritized list of client meetings, along with the pre-meeting materials, via a user interface to the financial advisor; and
rebalance the portfolios of clients based on the actionable recommendations generated by the AI/ML model and input from the financial advisor, wherein the rebalance is executed through integration with one or more portfolio management systems.

18. The system of claim 17, wherein the processor is further configured to process historical market event data in conjunction with real-time data to enhance accuracy of predicting the impact of current market events on financial sectors and client portfolios, wherein the processor adjusts the analysis based on historical performance trends of the financial sectors and individual portfolios.

19. The system of claim 17, wherein the processor is further configured to incorporate sentiment analysis of market news and social media content to determine an overall sentiment data towards the financial sectors and one or more products relevant to the client portfolios, wherein the overall sentiment data is used to weight the impact of the market events on financial sectors and the client portfolios.

20. The system of claim 17, wherein the processor is further configured to analyze geographical impacts by evaluating how the market events affect different regions and adjust impact assessment based on geographical relevance to the client portfolios, wherein the impact is evaluated by comparing it with geographic market trends and regional economic conditions.

21. The system of claim 17, wherein the processor is further configured to evaluate industry-specific impacts by analyzing how the market events influence various industries relevant to the client's portfolio, wherein the processor maps industry impacts to individual financial instruments and sectors within the client portfolios to determine specific effects.

22. The system of claim 17, wherein the processor is further configured to integrate client-specific data including risk profiles, investment goals, and historical performance to customize the impact analysis for individual portfolios.

23. The system of claim 17, wherein the processor is further configured to utilize predictive analytics to forecast future impacts of the market events on financial sectors and client portfolios based on current trends and historical data, wherein the forecast enables generation of actionable insights and recommendations for financial advisors.

24. The system of claim 17, wherein the processor is further configured to employ clustering techniques to group similar market events of the market events and their effects on financial sectors, facilitating pattern recognition and trend analysis that influence the impact on the client's portfolio.

25. The system of claim 17, wherein generating the prioritized list of client meetings comprises:
assigning priority scores to each client based on the significance of the impact of the analyzed market events on their respective portfolios; and
ranking clients by their priority scores to create a list of meetings ordered according to urgency and importance of addressing each client's portfolio needs.

26. The system of claim 25, wherein the significance of the impact is determined based on one or more of a degree of deviation from expected portfolio performance as influenced by the market events and potential financial implications for the client, considering both short-term and long-term effects on their investments.

27. The system of claim 17, wherein the processor is further configured to automatically generate pre-meeting materials comprising:
summarizing key points from the impact analysis of the market events on the client's portfolio to prepare the financial advisor for the meeting;
identifying key topics relevant to a client's portfolio performance, market trends, and investment opportunities based on the impact analysis; and
formulating customized investment strategies and portfolio adjustments based on the impact of the market events and the client's portfolio needs.

28. The system of claim 17, wherein the pre-meeting materials are customized based on at least one of a client's individual risk profile, financial goals, and historical portfolio performance, and real-time impact assessments.

29. The system of claim 17, wherein the pre-meeting materials including meeting notes, discussion items, and actionable recommendations are customized based on a client's individual risk profile, financial goals, and historical portfolio performance, and real-time impact assessments are recorded in a client relationship management (CRM) system.

30. The system of claim 17, further comprising integrating the generated prioritized list with a calendar system to automatically schedule the prioritized client meetings.

31. The system of claim 17, wherein the user interface allows the financial advisor to manually adjust the prioritization based on one or more factors.

32. The system of claim 17, further comprising:
providing a detailed impact report that includes analysis of market news, geographical impact, sentiment determination, and industry impact; and
delivering actionable insights and predictive recommendations to the financial advisor for enhancing client interactions and portfolio management.
